(19) United States
(12) Patent Application Publication
(10) Pub. No.: US 2002/0061182 A1
(43) Pub. Date: May 23, 2002

(54) VIDEO SIGNAL RECORDING APPARATUS, VIDEO SIGNAL RECORDING/REPRODUCING METHOD AND VIDEO SIGNAL RECORDING METHOD

(76) Inventor: KENJI NAKAMURA, KANAGAWA (JP)

Correspondence Address: FROMMER LAWRENCE & HAUG, 745 FIFTH AVENUE- 10TH FL., NEW YORK, NY, 10151, US

(21) Appl. No.: 09/251,167

(22) Filed: Feb. 17, 1999

(30) Foreign Application Priority Data
Feb. 19, 1998 (JP) 10-037062

(51) Int. Cl. H04N 5/76; H04N 5/225; H04N 5/781

(52) U.S. Cl. 386/55; 386/117; 386/125

(57) ABSTRACT

A video signal recording apparatus capable of recording video-audio signals simultaneously on a plurality of writable optical disks. The apparatus comprises a plurality of recording means for recording video signals on disk-shaped recording media respectively, a control means for controlling the recording operations of the plurality of recording means, a storage means where data indicating the relationship between each portion of the video signals to be recorded and the plurality of recording means are previously stored, and a video signal supply means controlled by the control means in accordance with the data stored in the storage means, supplying the video signals to one or more recording means selected out of the plurality of recording means. The video signal recording apparatus further comprises a compression means for compressing the video signals. Since signals can be recorded on a plurality of optical disks simultaneously, the recorded disks can be handed over to clients immediately upon completion of the recording. Thus the operability of the apparatus is enhanced, and the required number of hardware can be curtailed.

### BACKGROUND OF THE INVENTION

The present invention relates to a video signal recording apparatus and a video signal recording method, more particularly to those capable of recording signals simultaneously on a plurality of recording media.

There are known heretofore services rendered in various meetings and events, such as wedding ceremonies, to record video and audio signals, which are obtained from a video camera, on a plurality of tapes simultaneously and to distribute the recorded tapes to attendants of such a ceremony immediately after completion of the event. FIG. 1 is a block diagram showing an exemplary configuration of a related art system adopted to produce recorded tapes. Images of moving pictures formed by one or more video cameras 10 are edited in real time and then are outputted to a distributor 61 which distributes video-audio signals.

The outputs of the distributor 61 are supplied to a plurality of VTRs 62 to 64 for recording the signals on a plurality of tapes respectively. There is also proposed another system which employs a single apparatus to record signals simultaneously on a plurality of tapes.

However, in any of the related art recorded tape producing systems described above, there exists a problem that, since video tapes are employed as recording media, it is impossible to reproduce desired scenes instantly in a reproduction mode to consequently bring about some inconvenience in use.

### SUMMARY OF THE INVENTION

It is therefore an object of the present invention to provide a video signal recording apparatus and a video signal recording method which employ a plurality of writable optical disks as recording media, and are capable of recording signals simultaneously on such optical disks.

According to one aspect of the present invention, there is provided a video signal recording apparatus which includes a plurality of recording means for recording video signals on disk-shaped recording media respectively, a control means for controlling the recording operations of the plurality of recording means, a storage means where data indicating the relationship between each portion of the video signals to be recorded and the plurality of recording means are previously stored, and a video signal supply means controlled by the control means in accordance with the data stored in the storage means, supplying the video signals to one or more recording means selected out of the plurality of recording means.

According to another aspect of the present invention, the video signal recording apparatus further includes a compression means for compressing the video signals.

According to a further aspect of the present invention, there is provided a video signal recording/reproducing method which includes the steps of recording video signals on a plurality of disk-shaped recording media, storing data indicative of the recording start time and end time of each portion of the video signals and also indicative of the necessity or unnecessity of reproducing the signal portion with regard to each of the disk-shaped recording media, and reproducing, from the disk-shaped recording media in accordance with the stored data, the video signal portion indicated to be reproduced by the data that indicate the necessity or unnecessity of reproduction.

And according to a still further aspect of the present invention, there is provided a video signal recording method which includes the steps of storing data indicative of the relationship between each portion of video signals to be recorded and a plurality of disk-shaped recording media, and recording, in accordance with the stored data, the video signals on one or more disc-shaped recording media selected out of the plurality of disk-shaped recording media.

Thus, in the present invention, signals can be recorded on a plurality of optical disks simultaneously, so that the recorded disks can be handed over to clients immediately upon completion of the recording. In comparison with the known case of using a plurality of individual recorders, the operability of the apparatus is enhanced with further advantages of down-sizing the overall system and diminishing the required number of hardware therein.

The above and other features and advantages of the present invention will become apparent from the following description which will be given with reference to the illustrative accompanying drawings.

### BRIEF DESCRIPTION OF THE DRAWINGS

FIG. 1 is a block diagram showing an exemplary configuration of a related art recorded tape producing system;

FIG. 2 is a block diagram showing a configuration of an embodiment which represents the video signal recording apparatus of the present invention;

FIG. 3 is an explanatory diagram relative to exemplary contents of an edit list;

FIG. 4 is a diagram for explaining a recording operation by positions on tracks to be recorded;

FIG. 5 is a diagram for explaining another method of recording entire scenes on entire disks;

FIG. 6 is a perspective view of a first structural example of the embodiment representing the video signal recording apparatus of the present invention; and

FIG. 7 is a perspective view of a second structural example of the embodiment representing the video signal recording apparatus of the present invention.

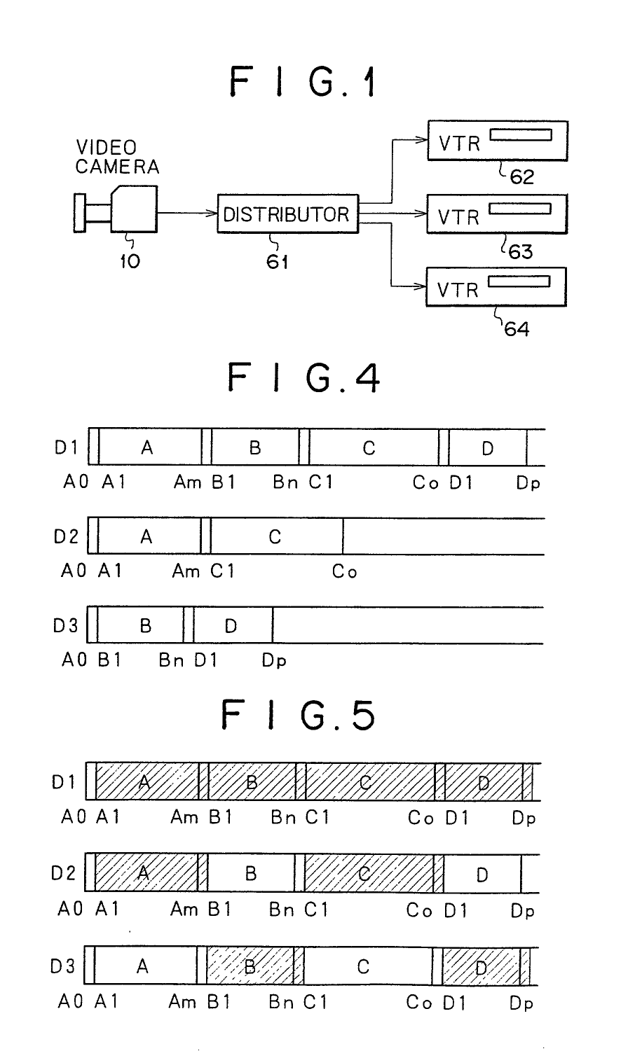

### DETAILED DESCRIPTION OF THE PREFERRED EMBODIMENTS

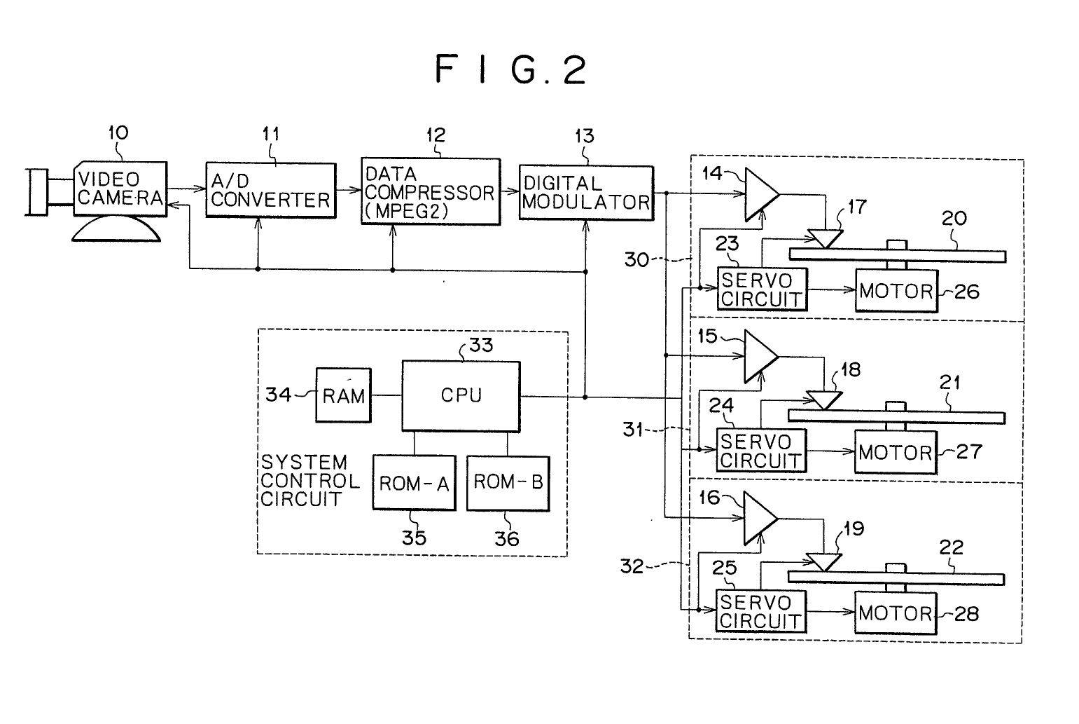

Hereinafter some preferred embodiments of the present invention will be described in detail with reference to the accompanying drawings. FIG. 2 is a block diagram showing an exemplary configuration of an embodiment which represents the video signal recording apparatus of the present invention. In this diagram, a video camera 10 converts images, which have been formed by a CCD image sensing device for example, into electric signals to generate video and audio signals conforming with the NTSC system.

An A/D converter 11 converts the analog video-audio signals outputted from the video camera 10 into digital signals. A data compressor 12 compresses the digital video-audio signals in accordance with the known MPEG2 standard for example. A digital modulator 13 performs digital modulation (block encoding with, e.g., eight-to-sixteen conversion: recording code conversion) for recording the compressed signals on optical disks 20 to 22.

Drive devices 30 to 32 are structurally the same and write the video-audio information on the optical disks 20 to 22 independently of each other. Explaining one drive device 30 for example, a drive circuit 14 responds to the output signal of the digital modulator 13 and drives a semiconductor laser element incorporated in a head 17. A servo circuit 23 executes feedback control of the position of the head 17 or the rotation rate of a motor 26 in response to the track information detected by an optical detecting device such as a photo diode incorporated in the head 17.

Since the writing operations of the drive devices 30 to 32 are not synchronized completely with each other, common or separate buffer memory circuits are disposed between the digital modulator 13 and the drive circuits 14 to 16 to attain synchronism with the individual drive devices.

A system control circuit comprises a CPU 33, a RAM 34, a ROM-A 35, and a ROM-B 36 which is a nonvolatile memory such as EEPROM, wherein the CPU 33 controls the whole video signal recording apparatus in accordance with a control program stored in the ROM-A 35. An internal clock indicating each unit of hours, minutes, seconds and frames is set in the ROM-B 36 in a manner to advance stepwise per frame with the lapse of time. In a writing (recording) mode, the CPU 33 executes time-division control of the drive devices 30 to 32 for enabling the same to write the output information of the digital modulator 13 respectively on the optical disks 20 to 22 independently of each other.

The optical disks usable as recording media are those based on the DVD-R format, and any optical disk recordable per field may be employed, such as a DVD-RAM (phase change type optical disk), CD-R, CD-RW or MO (magneto-optical disk). And the drive devices adopted in this embodiment correspond to the kind of the employed optical disk. In one rotation of 360° of the disk, each of the drive devices 30 to 32 records video-audio signals by a frame along with one spiral track on the disk from inside to outside thereon.

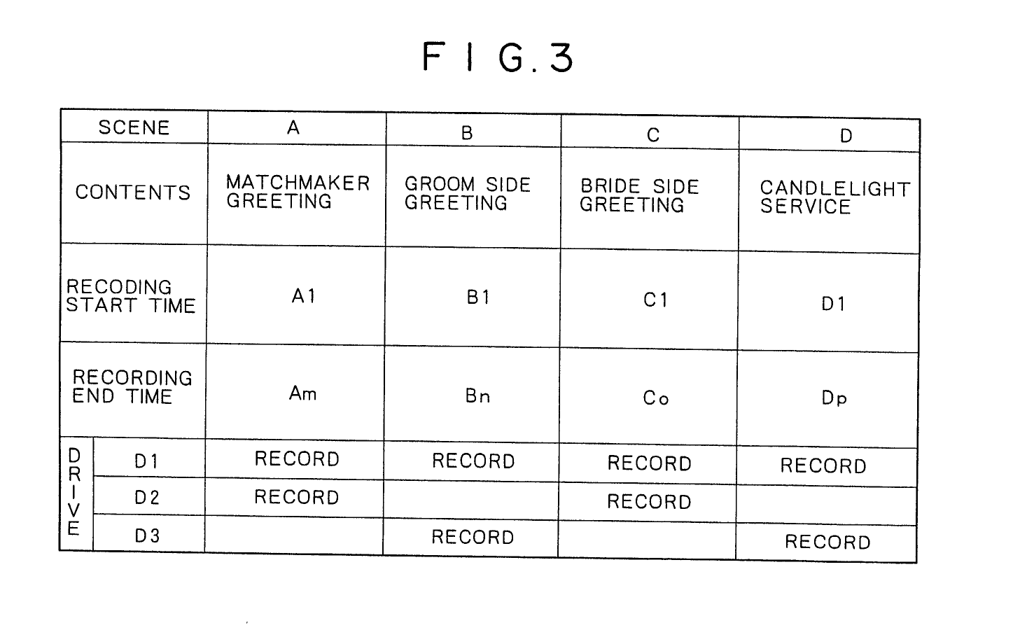

FIG. 3 is an explanatory diagram showing exemplary contents of an edit list obtained by recording the information that indicates how the scenes shot by the camera 10 are selected and recorded by the drive devices D1 (30), D2 (31) and D3 (32) in FIG. 2. This edit list signifies assignment of the drive devices for recording scenes A, B, C and D shot in a wedding ceremony hall for example. In the example of FIG. 3, the drive device D1 records the entire scenes A, B, C and D. The drive device D2 records merely scenes A and C while holding scenes B and D in a standby mode; and the drive device D3 records merely scenes B and D while holding scenes A and C in a standby mode.

The edit list data is previously set and stored in the memory, RAM 34, of FIG. 2 by a camera operator, and when necessary, the list can be displayed on the viewfinder of the camera so that the data is usable for deciding shooting arrangements/scheduling. The recording start time and end time of each scene on the list are corrected automatically according to the internal clock, in response to commands sent from the CPU at the recording start and end times of each scene.

When the drive devices are in a standby mode, the disk rotation servos, focus servos and tracking servos are all locked completely, so that the servos can be placed in a recording mode immediately upon pressing a record button by the operator. In any recorder using tapes as recording media, there may occur troubles of head clog, tape damage and so forth in case the recorder is held long in the standby mode. It is therefore impossible in any tape recorder to perform the above-described operation, which is achievable due to advantageous effects of optical disks. The scene information is successively shifted from scene A to scene B, from B to C, and from C to D per cycle of recording start to end.

FIG. 4 is an explanatory diagram where a system control action is shown by positions on record tracks. First, when the operator presses the recording button, the CPU 33 places the drive devices D1 and D2 in a recording mode according to the edit list preset in the RAM 34, while holding the drive device D3 in a standby mode. The internal clock is started to advance stepwise.

If the operator depresses the record button again at time Am in this state, the drive devices D1 and D2 are caused to stop recording and are placed in a standby mode similarly to D3. On the edit list, A1 and Am denote the recording start time and the recording end time respectively, and are corrected in conformity with those of the internal clock stored previously in the ROM-B 36. It is supposed here that, due to the action performed already by the CPU 33, the operation relative to scene A on the edit list has been completed, and then proceeds to next scene B.

When the record button is pressed twice at scene B as in the foregoing case, the video-audio signals are recorded in portions B of the drive devices D1 and D3, and times B1 and Bn on the edit list are corrected in conformity with those of the internal clock. Similarly, at scenes C and D also, the operations of recording the video-audio signals and correcting the recording start and end times are performed according to the edit list.

After completion of recording the video and audio signals, the edit list thus corrected with regard to the recording start and end times is recorded in a content track formed in the innermost radius of the disk, so as to be utilized as a table of contents when the user handles the disk later.

In the operation described above, shift of scene modes is performed automatically per cycle of recording start and end by pressing the record button. However, it is also possible for the operator to shift scene modes at any desired time by means of an independent manipulation of the button. It is further possible to execute automatic shift of scene modes at a preset time in accordance with the clock information.

FIG. 5 is an explanatory diagram of a second method which employs the same edit list and enables the entire drive devices D1, D2 and D3 to record all scenes. In a recording mode, the video and audio signals of all scenes are recorded on all the disks as shown in FIG. 5, wherein recording start and end times are corrected on the edit list in conformity with the internal clock.

When the user reproduces the disk in a player, firstly edit list recorded on the innermost radius is read, and then the recorded signals are reproduced in accordance with the edit list. In the example of FIG. 5, only the scenes shaded with oblique lines are reproduced since it is referred to as “recorded” on the edit list.

For example, in reproducing the disk recorded by the drive device D3, the system control circuit in the player first reads the content track recorded on the innermost radius, then reads the time A1 recorded in the next outer track together with the video-audio signals, and compares the time A1 with the first time B1 on the edit list in the table of content track. If the result of this comparison by the system control circuit signifies that B1 is greater, a pickup in the player is jumped to the track corresponding to the time B1 and then starts reproduction.

And when the time on the disk has reached at, during reproduction of the video-audio signals, the end time Bn of scene B on the edit list, the pickup is jumped to the first track D1 of the next scene D and starts reproduction. Therefore, the user feels as if he is viewing the edited disk shown in FIG. 4.

The user is enabled to select any desired scene by rewriting the edit list later. On a DVD-R disk where recording is permitted merely once, correction is rendered possible by adopting a system in which the last-written content is read while an unwritten portion is always left on the edit list. As long as there remains the unwritten portion, correction is made. The above operation realizes a so-called electronic album where the advantageous features of optical disks are maximally utilized.

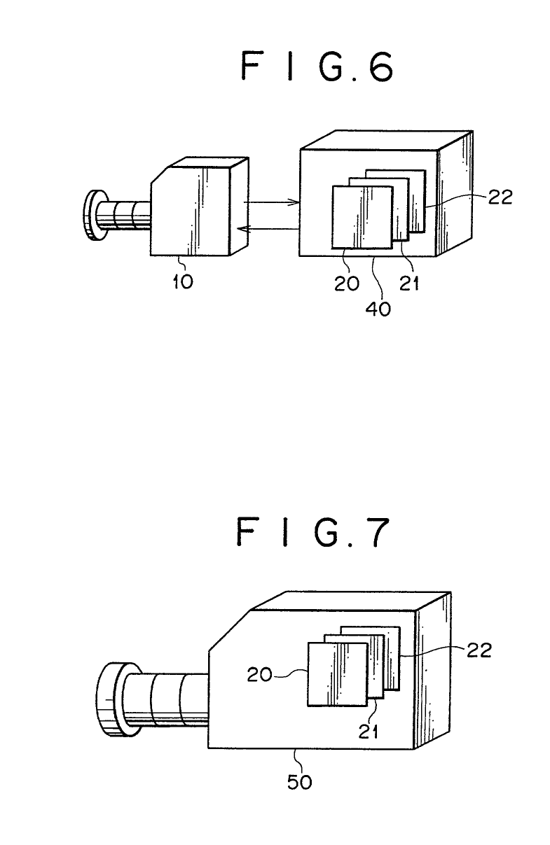

FIG. 6 is a perspective view illustrating a first structural example of the embodiment which represents the video signal recording apparatus of the present invention. In this first structural example, a video camera 10 and a recorder 40 are provided separately. Drive devices (30 to 32) for a plurality of optical disks 20 to 22 are incorporated in the recorder. Due to such a structure, the recorder 40 itself can be down-sized to consequently achieve enhanced portability. And any known video camera or editing device is also usable.

Depending on the number of optical disks required for recording, a plurality of recorders 40 may be connected in parallel or series so as to correspond in number to the disks. For this purpose, input and output terminals for analog or digital video-audio signals may be provided as well.

FIG. 7 is a perspective view illustrating a second structural example of the embodiment which represents the video signal recording apparatus of the present invention. In this example, a video camera and a recorder are housed integrally to constitute a single structure. In the recorder 50, a camera and drive devices (30 to 32) for a plurality of optical disks 20 to 22 are incorporated. Due to this structure, a cameraman carrying the video signal recording apparatus is enabled to walk around freely in a hall or the like.

In the structural example of FIG. 7 also, it is possible for the single recorder 50 to record signals on a plurality of optical disks. And depending on the number of optical disks required for recording, a plurality of recorders 40 shown in FIG. 6 may be connected externally so as to correspond in number to the optical disks.

Although the present invention has been described hereinabove with regard to some embodiments thereof, the following modifications may also be contrived. Each of the embodiments represents an example where the recorder is equipped with three drive devices. However, the number of such drive devices is not limited thereto alone, and drive devices may be detachably installed so as to be increased to a desired number with facility, as in a drive bay formed in a personal computer for example to accommodate CD-ROM drive devices.

In case the video signal recording apparatus is equipped with two or more drive devices, it may be so actuated that, during a recording operation of one drive device, the disk loaded in the other drive device is replaced with new one, and when the remaining capacity of the disk being used for recording comes nearly to none, the other disk is started for recording, whereby continuous long-time video recording is rendered possible correspondingly to plural disks.

In further modifications, the video data recorded on one disk may be copied onto the other disk, or a third disk may be produced by mixing and dubbing the video data of two disks at a desired ratio, so that the recorded images can be edited in a single apparatus.

Thus, the video signal recording apparatus mentioned above employs writable optical disks, and it comprises a plurality of optical disk write means and a single control means for controlling the writing operations of the plural optical-disk write means, wherein signals can be recorded on the plural optical disks simultaneously to thereby ensure excellent rapidity and economy in the one-man operated video signal recording apparatus.

A further advantageous effect is achievable in the point that a single video signal recording apparatus is sufficient to perform satisfactory shooting which meets different editing requirements from a plurality of clients.

In addition, simplified retrieval of the recorded data can be attained by registering edit time points on a content list recorded in the innermost track of each disk, and the contents to be edited are changeable later with remarkable facility.

What is claimed is:

1. A video signal recording apparatus comprising:
a plurality of recording means for recording video signals on disk-shaped recording media respectively;
a control means for controlling said recording operations of said plurality of recording means;
a storage means where data indicating the relationship between each portion of said video signals to be recorded and said plurality of recording means are previously stored; and
a video signal supply means controlled by said control means in accordance with the data stored in said storage means, supplying the video signals to one or more recording means selected out of said plurality of recording means.

2. The video signal recording apparatus according to claim 1, further comprising a compression means for compressing the video signals.

3. A video signal recording/reproducing method comprising the steps of:
recording video signals on a plurality of disk-shaped recording media;
storing data indicative of the recording start time and end time of each portion of the video signals and also indicative of the necessity or unnecessity of reproducing said signal portion with regard to each of the disk-shaped recording media; and
reproducing, from the disk-shaped recording media in accordance with the stored data; the video signal portion indicated to be reproduced by said data that indicate the necessity or unnecessity of reproduction.

4. A video signal recording method comprising the steps of:
storing data indicative of the relationship between each portion of video signals to be recorded and a plurality of disk-shaped recording media; and
recording, in accordance with the stored data, said video signals on one or more disc-shaped recording media selected out of said plurality of disk-shaped recording media.
